(19) United States
(12) Patent Application Publication
(10) Pub. No.: US 2014/0233378 A1
(43) Pub. Date: Aug. 21, 2014

(54) Method and Apparatus to Lower Capacity Requirements on Backhaul Interface Between Base Stations

(71) Applicants: Petri Olavi Jappila, Espoo (FI); Hannu Tapio Hakkinen, Espoo (FI); Christian Mahr, Ulm (DE)

(72) Inventors: Petri Olavi Jappila, Espoo (FI); Hannu Tapio Hakkinen, Espoo (FI); Christian Mahr, Ulm (DE)

(21) Appl. No.: 14/241,477

(22) PCT Filed: Aug. 30, 2011
(86) PCT No.: PCT/EP2011/064898

§ 371 Date: May 1, 2014

(51) Int. Cl. H04W 28/02

(52) U.S. Cl. CPC H04W 28/0231
USPC 370/230

(57) ABSTRACT

Method and apparatus for processing in a non serving base station received data from at least one user equipment in order to reduce said data; and causing that the processed data are sent to a base station.

The invention relates a method and apparatus and in particular but not exclusively to a method and apparatus for use in a base station.

A communication system can be seen as a facility that enables communication sessions between two or more entities such as fixed or mobile communication devices, base stations, servers and/or other communication nodes. A communication system and compatible communicating entities typically operate in accordance with a given standard or specification. A communication can be carried on wired or wireless carriers. In a wireless communication system at least a part of the communication between at least two stations occurs over a wireless link.

Examples of wireless systems include public land mobile networks (PLMN) such as cellular networks, satellite based communication systems and different wireless local networks, for example wireless local area networks (WLAN).

A user can access the communication system by means of an appropriate communication device. A communication device of a user is often referred to as user equipment (UE) or terminal. Typically a communication device is used for enabling receiving and transmission of communications such as speech and data. In wireless systems a communication device provides a transceiver station that can communicate with another communication device such as e.g. a base station of an access network and/or another user equipment. The communication device may access a carrier provided by a station, for example a base station, and transmit and/or receive communications on the carrier.

An example of communication systems attempting to satisfy the increased demands for capacity is an architecture that is being standardized by the 3rd Generation Partnership Project (3GPP). This system is often referred to as the long-term evolution (LTE) of the Universal Mobile Telecommunications System (UMTS) radio-access technology. The LTE aims to achieve various improvements, for example reduced latency, higher user data rates, improved system capacity and coverage, reduced cost for the operator and so on. A further development of the LTE is often referred to as LTE-Advanced. The various development stages of the 3GPP LTE specifications are referred to as releases.

LTE-A—includes a proposal for CoMP (coordinated multipoint) which is a method of transmitting to or receiving from a user equipment using several base stations. This may have advantages relating to throughput, for example for user equipment located in cell edge regions.

For uplink CoMP, this may require two or more base stations which receive signals from the user equipment to communicate so one base station receives data from another. This data is relatively large and may require relatively low latency. Accordingly, with current proposals, a large capacity interface is required between the base stations.

According to an aspect, there is provided an apparatus comprising at least one processor, and at least one memory including computer program code, wherein the at least one memory and the computer program code are configured, with the at least one processor: to process received data in a non serving base station from at least one user equipment to reduce said data; and to cause said processed data to be sent to a serving base station.

According to another aspect, there is provided an apparatus comprising at least one processor, and at least one memory including computer program code, wherein the at least one memory and the computer program code are configured, with the at least one processor: to cause a request from a serving base station to be sent to a non serving base station, said request comprising information for causing said non serving base station to reduce an amount of data to be sent from said non serving base station to said serving base station.

According to another aspect, there is provided an apparatus comprising means for causing a request from a serving base station to be sent to a non serving base station, said request comprising information for causing said non serving base station to reduce an amount of data to be sent from said non serving base station to said serving base station.

According to a further aspect, there is provided a method comprising processing received data in a non serving base station from at least one user equipment to reduce said data; and causing said processed data to be sent to a serving base station.

According to a further aspect, there is provided a method comprising means for causing a request from a serving base station to be sent to a non serving base station, said request comprising information for causing said non serving base station to reduce an amount of data to be sent from said non serving base station to said serving base station.

According to a another aspect, there is provided an apparatus comprising means for processing received data in a non serving base station from at least one user equipment to reduce said data; and means for causing said processed data to be sent to a serving base station.

The processing means may be configured to process said received data to reduce a resolution of said data.

The processing means may be configured to reduce the number of bits per sample of said data.

The processing means may be configured to reduce the resolution of IQ data.

The apparatus may be configured to receive from said serving base station a request to reduce said resolution of said data.

The processing means may be configured to perform fast Fourier transformation of said data.

The processing means may be configured to perform demodulation of said data.

The processing means may be configured to perform decoding of said data.

The processing means may be configured to use cell specific parameters from said serving base station for processing of said received data.

The causing means may be configured to cause said data to be sent only when scheduled.

At least one of said processing means and said causing means may be controlled responsive to information from said serving base station.

The causing means may be configured to send one of IQ data, soft symbols or hard symbols to said serving base station.

The causing means may be configured to cause said processed data to be sent to said serving base station on an X2 link.

The causing means may be configured to provide said processed data only of user equipments which are controlled by said serving base station.

The processing means may be configured to carry out a check on said data and said causing means only causes said data to be sent if said check is successful.

The check may comprise a cyclic redundancy check.

According to another aspect, there is provided an apparatus comprising: means for causing a request from a serving base station to be sent to a non serving base station, said request comprising information for causing said non serving base station to reduce an amount of data to be sent from said non serving base station to said serving base station.

The information may comprises at least one of:

information for reducing a resolution of said data;
information for reducing the number of bits per sample of said data;
information for reducing the resolution of said data in IQ form;
information on cell specific parameters for processing of said data in the non serving base station;
user equipment scheduling information;
information defining if said data is IQ data, soft symbols or hard symbols; and
information for causing data only of user equipments which are controlled by said serving base station to be sent to said serving base station.

Embodiments will now be described, by way of example only, with reference to the following examples and accompanying drawings, in which:

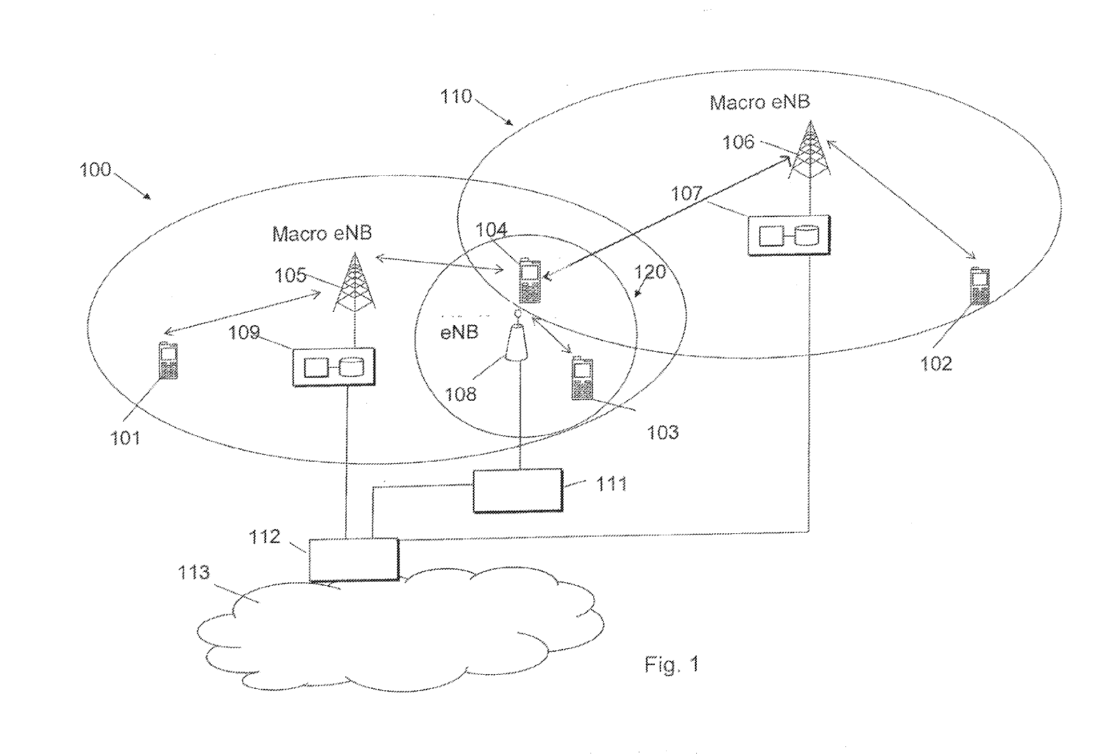

FIG. 1 shows a schematic diagram of a network according to some embodiments;

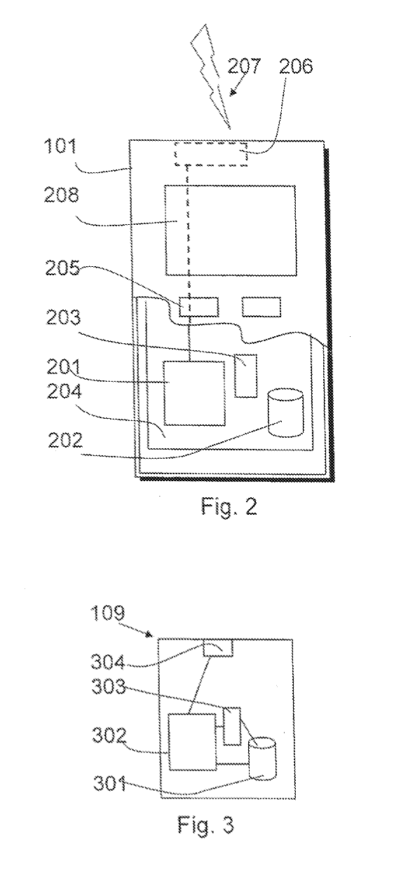

FIG. 2 shows a schematic diagram of a mobile communication device according to some embodiments;

FIG. 3 shows a schematic diagram of a control apparatus according to some embodiments;

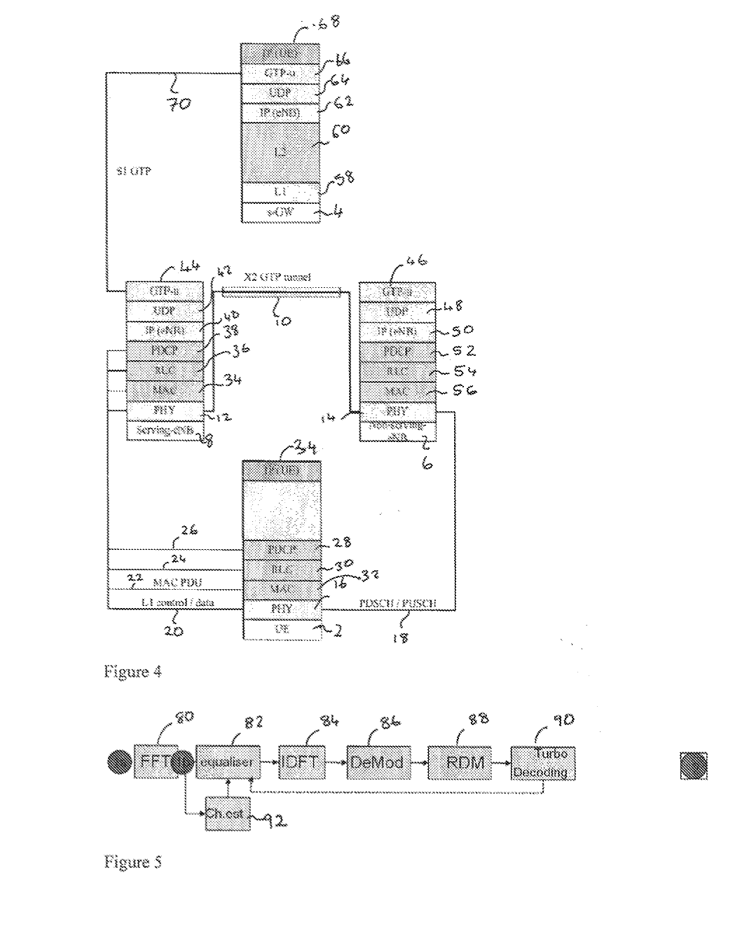

FIG. 4 shows schematically communication between user equipment and base stations, at the layer level;

FIG. 5 shows schematically part of a data processing chain at a base station level;

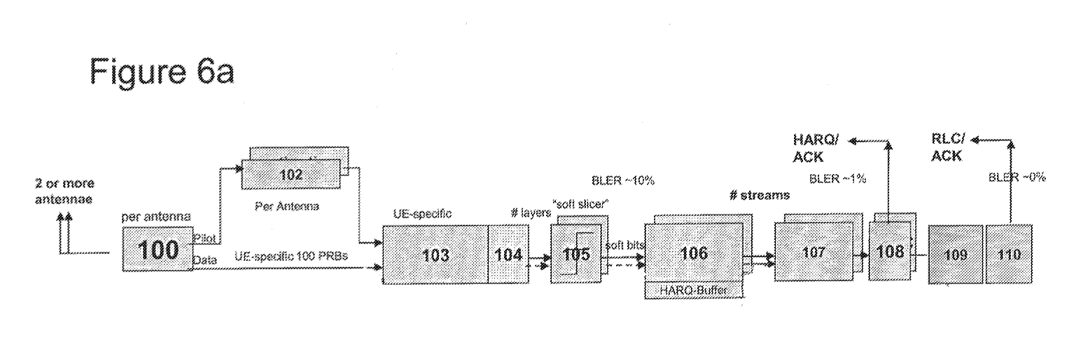

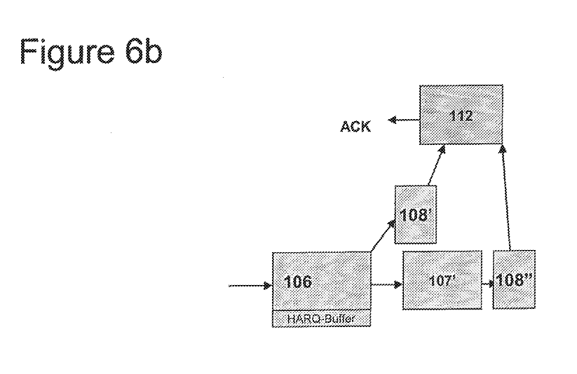

FIG. 6a shows in more detail a receiver chain; and

FIG. 6b shows a part of a modified receiver chain.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A mobile communication device or user equipment 101, 102, 103, 104 is typically provided wireless access via at least one base station or similar wireless transmitter and/or receiver node of an access system. In FIG. 1 three neighbouring and overlapping access systems or radio service areas 100, 110 and 120 are shown being provided by base stations 105, 106, and 108.

However, it is noted that instead of three access systems, any number of access systems can be provided in a communication system. An access system can be provided by a cell of a cellular system or another system enabling a communication device to access a communication system. A base station site 105, 106, 108 can provide one or more cells. A base station can also provide a plurality of sectors, for example three radio sectors, each sector providing a cell or a subarea of a cell. All sectors within a cell can be served by the same base station. A radio link within a sector can be identified by a single logical identification belonging to that sector. Thus a base station can provide one or more radio service areas. Each mobile communication device 101, 102, 103, 104, and base station 105, 106, and 108 may have one or more radio channels open at the same time and may send signals to and/or receive signals from more than one source.

Base stations 105, 106, 108 are typically controlled by at least one appropriate controller apparatus 109, 107 so as to enable operation thereof and management of mobile communication devices 101, 102, 103, 104 in communication with the base stations 105, 106, 108. The control apparatus 107, 109 can be interconnected with other control entities. The control apparatus 109 can typically provided with memory capacity 301 and at least one data processor 302. The control apparatus 109 and functions may be distributed between a plurality of control units. Although not shown in FIG. 1 in some embodiments, each base station 105, 106 and 108 can comprise a control apparatus 109, 107.

The cell borders or edges are schematically shown for illustration purposes only in FIG. 1. It shall be understood that the sizes and shapes of the cells or other radio service areas may vary considerably from the similarly sized omni-directional shapes of FIG. 1.

In particular, FIG. 1 depicts two wide area base stations 105, 106, which can be macro-eNBs 105, 106. The macro-eNBs 105, 106 transmit and receive data over the entire coverage of the cells 100 and 110 respectively. FIG. 1 also shows a smaller base station or access point which in some embodiments can be a pico eNB 108. The coverage of the smaller base station 108 may generally be smaller than the coverage of the wide area base stations 105, 106. The coverage provided by the smaller node 108 overlap with the coverage provided by the macro-eNBs 105, 106. In some embodiments, the smaller node can be a femto or Home eNB. Pico eNBs can be used to extend coverage of the macro-eNBs 105, 106 outside the original cell coverage 100, 110 of the macro-eNBs 105, 106. The pico eNB can also be used to provide cell coverage in “gaps” or “shadows” where there is no coverage within the existing cells 100, 110 and/or may serve “hot spots”.

As shown, the radio service areas can overlap. Thus signals transmitted in an area can interfere with communications in another area (macro to macro and pico to either one or both of the macro cells).

It should be noted that in some embodiments the pico eNB or smaller eNBs may not be present. In alternative embodiments, only pico or smaller eNBs may be present. In some embodiments there may be no macro eNBs.

The communication devices 101, 102, 103, 104 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

Some non-limiting examples of the recent developments in communication systems are the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

In FIG. 1 the base stations 105, 106, 108 of the access systems can be connected to a wider communications network 113. A controller apparatus 107, 109 may be provided for coordinating the operation of the access systems. A gateway function 112 may also be provided to connect to another network via the network 113. The smaller base station 108 can also be connected to the other network by a separate gateway function 111. The base stations 105, 106, 108 can be connected to each other by a communication link for sending and receiving data. The communication link can be any suitable means for sending and receiving data between the base stations 105, 106 and 108 and in some embodiments the communication link is an X2 link.

The other network may be any appropriate network. A wider communication system may thus be provided by one or more interconnect networks and the elements thereof, and one or more gateways may be provided for interconnecting various networks.

The mobile communication devices will now be described in more detail in reference to FIG. 2. FIG. 2 shows a schematic, partially sectioned view of a communication device 101 that a user can use for communication. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

The mobile device 101 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus 109 for a communication system, for example to be coupled to and/or for controlling a station of an access system. In some embodiments the base stations 105, 106, and 108 may incorporate a control apparatus 109. In other embodiments the control apparatus can be another network element. The control apparatus 109 can be arranged to provide control of communications by mobile communication devices that are in the service area of the system. The control apparatus 109 comprises at least one memory 301, at least one data processing unit 302, 303 and an input/output interface 304. Via the interface the control apparatus can be coupled to a receiver and a transmitter of the base station. The control apparatus 109 can be configured to execute an appropriate software code to provide the control functions.

Embodiments may use CoMP. This may enable higher capacity on the cell edges by combining data from several base stations. This may require there to be a significant transport capacity between the base stations. In some embodiments CoMP can be used to improve the uplink with uplink processing for joint transmitting/joint processing (JT/JP) CoMP. For example the communication device 104 is able to communicate with both base station 105 and 106.

Reference is made to FIG. 4 which shows schematically a first user equipment 2, a first base station 6, a second base station 8 and a signalling gateway 4. In the arrangement shown in FIG. 4, the first base station 6 is the non-serving base station and the second base station 8 is the serving base station. The serving base station is the base station which controls the user equipment and the CoMP set. The non-serving base station is the base station which supports the serving base station in the reception/transmission process.

FIG. 4 shows the layer structure of the entities shown. It should be noted that FIG. 4 shows only one example of layered structure. It is possible that layering is done differently in alternative embodiments.

The user equipment 2 has a physical PHY layer 16, a medium access control MAC layer 32, a radio link control RLC layer 30, a packet data convergence protocol PDCP layer, and an internet protocol layer 34.

Each of the serving and non-serving base stations has a respective PHY layer 12, 14, a respective MAC layer 34, 56, a respective RLC layer 36, 54, a respective PDCP layer 38, 52, a respective IP layer 40, 50, a respective user datagram protocol UDP layer 42, 48 and respective GPRS (general packet radio service) tunnelling protocol GTP-u layer 44, 46.

The gateway 4 likewise has a first layer L1 58, a second layer L2 60, an IP layer 62, a UDP layer 64, a GTP-U layer 66 and an IP layer 68. The first IP layer 62 is in respect of the base station and the second IP layer 68 is in respect of the user equipment.

The uplink data from the UE is sent to the non-serving BTS 6 at the PHY level. In particular, uplink data is sent on the PUSCH channel (physical uplink shared channel). On the downlink side, communication is via the PDSCH (physical downlink shared channel), again referenced 18. Again the PDSCH is at the PHY level.

Between the user equipment 2 and the serving base station, L1 control information and data, referenced 20 is sent between the PHY layers 16 and 12 of the user equipment and serving base station respectively. This data again may be sent via the PDSCH and/or the PUSCH.

MAC packed data units PDU, referenced 22 is sent between the MAC layers 32 and 34 respectively of the user equipment and the serving base station. RLC data, referenced 24 and PDCP data referenced 26 is provided between the respective RLC layers and the PDCP layers of the user equipment and the serving base station.

An X2 GTP tunnel 10 is provided between the physical layer 12 of the serving base station 8 and the physical layer 14 of the non-serving base station. The X2 link may be a wired and/or a wireless link.

GTP data referenced 70 is provided between the GTP layers 44 and 66 respectively of the serving base station 8 and gateway 4.

For a UE in a CoMP situation, the uplink data received by the non serving base station needs to be transferred to the serving base station. Wth current proposals, an X2 interface between the two base stations having a GBps (gigabytes per second) capacity may be required.

Currently, IQ data transmission from the non serving base station over the X2 connection 10 provides the capacity gains that can be obtained by using the CoMP scheme. For example, the IQ level data from the non serving base station is required by the serving base station for interference cancellation. Currently, IQ data transmission requires, for example, 1 GBps per antenna for a 20 MHz LTE cell.

The data rate may be reduced to several 100s of MBPS for the transmission of only soft symbol information. This is an initial determination of the symbol which has been transmitted. This will be described in more detail later.

Achieving high data rates with low latency may impose extreme requirements on the X2 interface. In some embodiments, data rates are reduced while preserving the CoMP advantages on the radio interface.

In some embodiments, the transport bandwidth and/or the delay requirements may be reduced. For example, the amount of data at cell level or user equipment level may be reduced. Instead of sending all the information from cell (basically all the information that is received in eNB radio receiver) from all the UEs may be sent to the serving eNB, in some embodiments, it is possible to send data that is valid only for some UEs that would benefit from CoMP.

A serving base station may identify the need for CoMP by analysing the user equipment measuring reports. Typically, CoMP may be used for those user equipment which are near to a cell edge. This information may for example include information about signal strengths of the serving base station and neighbouring base stations and/or interference levels. Alternatively or additionally any other suitable information which can indicate if a UE is a cell edge region may be used.

The serving base station may decide a set of cells for uplink CoMP based on this information. In the example shown in FIG. 4, the serving base station 8 and the non-serving base station 6 are selected for CoMP for the UE 2. It should be appreciated that this is by way of example, and in some scenarios more than two base stations may be involved.

The serving base station 8 will use the X2 communication channel to communicate with the non-serving base station. The serving base station will advise the non-serving base station 6 which information is required from that non-serving base station 6.

### Full Bandwidth Mode

A first full bandwidth mode will now be described.

Reduction in Resolution

The serving base station requests that the non-serving base station 6 send all the IQ data received via the non-serving base station from the user equipment. This will be the data which is received, for example, on the PUSCH. This may be done if there is a large X2 capacity or there is sufficient spare capacity on the X2 link. In one embodiment, the serving BTS will request that the non-serving BTS reduce the resolution of the IQ data. The resolution is the number of bits used to transmit a sample. Currently, the resolution is 2¹⁶ bits per sample. In one embodiment, the serving BTS can request that the number of bits per sample be reduced

In some embodiments, the serving base station will request the data at a lower resolution which may be predetermined.

In some embodiments, the serving BTS can select the resolution required.

In one alternative embodiment, the non-serving base station may select the lower resolution itself, dependent on for example the capacity and the X2 connection or the nature of the data received on the PUSCH.

There may be one or more lower resolutions. The magnitude of the resolutions available may be fixed or be variable.

In many cases, transmissions used with the CoMP scheme will use QPSK (quadrature phase shift keying) as the radio conditions between UE and eNB do allow the use of higher modulations (when UE is in the edge of cell and would benefit from COMP). Thus, a lower resolution will be sufficient.

For those UEs eligible for CoMP, the chances for relatively low MCS (modulation and coding scheme) are quite high, since those UEs are in a cell overlap region. Different MCS have different robustness against noise. A reduced quantisation can be regarded as additional noise. Relatively low MCS can tolerate more noise than a relatively high MCS.

In one embodiment, the maximum resolution used today uses filter encoding i.e. of 15 or 16 bits. This is used for the “best” MCS defined in 3GPP. QPSK may tolerate a reduction to for example 5 or 6 bits without significant impact. The final selection of resolution may be implementation dependent. A balance is made between the loss of resolution against the gain of having less bits to transport.

Carrying Out FFT in Non-Serving Base Station

Alternatively or additionally, the amount of data provided on the X2 link 10 can be reduced by carrying out the FFT (Fast Fourier Transformation) in the non-serving BTS 6 before transferring the data to the serving BTS. In this regard, reference is made to FIG. 5. This shows a chain of processing which is performed on received data by a base station. Firstly, a Fast Fourier Transform is applied by FFT block 80. The output of the FFT block 80 is input to an equalizer block 82. The output of the FFT block 80 is also input to a channel estimator 92, the output of which is also provided to the equalizer 82. The output of the equalizer 82 is input to an IDFT (Inverse Discrete Fourier Transform) block 84. The output of the IDFT block 84 is input to a demodulator 86, the output of which is input to a rate de-matching block 88. The output of the rate de-matching block 88 is input to a turbo decoding block 90 which has a feedback output back to the equalizer 82.

By carrying out the FFT process prior to transferring the data from the non-serving base station to the serving base station, it is possible to reduce the amount of data transferred. In order to permit the non-serving base station 6 to carry out the FFT processing, cell specific parameters may be transferred from the serving base station 8 to the non-serving base station 6.

It should be appreciated that in some embodiments, the FFT may be done in the non-serving BTS and additionally the serving BTS may request a reduction in the resolution of the sample transmitted across the X2 link. In other words, the sample will be transmitted with less bits per sample.

In some embodiments, the serving BTS is able to do processing such as interference rejection combining and/or maximal ratio combining on the data received by itself as well as data received by the non-serving base station, as the equalization and turbo decoding may be done in the serving BTS.

### Partial Bandwidth Method

In an alternative embodiment, a partial bandwidth mode is provided. The serving BTS will request that the non serving base station provide information during one or more defined transmission time intervals TTI. This may be based on real or predicted uplink scheduling information for the user equipments in the CoMP mode. For example a time multiplexing or time slot scheme is used for the non-serving base station to access the X2 link with the serving BTS.

As in LTE, uplink SCDMA (synchronous code division multiple access) is used. For example a certain range of consecutive of physical resource block PRBs (set of subcarriers) is assigned to a U and all UEs in a cell have to share for example 100 PRBs in 20 Mhz.

After FFT, only those frequencies allocated to a specific UE in CoMP mode needed to be transferred between the non-serving BTS and the serving BTS. This way the amount of information can be significantly reduced, for example linearly with the fraction of PRBs used by the UEs in question.

Cell Level Information Regarding Data to be Sent

In this mode, the serving BTS can request the non-serving BTS to send one of the IQ data, optionally without the FFT processing; soft coded symbols (an initial estimate of the symbol); or hard coded symbols (or a final determination of a symbol).

The serving BTS 8 can request that the non-serving base station send the data in a demodulated format. The data received at the non-serving BTS 6 is modulated. It may be in the QSPK modulation scheme. Demodulating that data prior to sending to the serving base station may reduce the data rates.

The serving cell may inform the non serving cell that it should assume that all data is for example QPSK modulated and then allow the non serving cell to send data in the demodulated

Alternatively or additionally, the serving BTS 8 may request a particular bandwidth and/or sample resolution be used by the non serving base station.

The serving base station requests that the particular bandwidth and sample resolution. This information allows the non-serving base station to send either the soft symbol data or the hard symbol data. The bandwidth is defined by a set of uplink PRBs.

If a non serving base station sends and assumes that the modulation was for example QPSK but the serving base station knows that it was 16QAM, then the serving base station knows that the received data is not correct and can omit the data received from the non serving base station.

The rules regarding the communication between the serving base station and the non-serving base station and in particular rules for the sending of data from the non-serving base station to the serving base station may be defined. These rules may be communicated to the non-serving base station. This may be done before the actual uplink scheduling process to reduce or avoid to the need to communicate these rules when the UE is in a CoMP mode and there is for example PUSCH data to be transferred to the serving base station.

Alternatively or additionally these rules may be communicated during the transfer of PUSCH data.

The serving BTS 8 may send to the non-serving base station information on the subcarriers to be used and/or TTI (transmission time interval) indicating when the data should be sent. If the serving BTS decides to use the radio resource for another purpose, the serving base station may just omit that data from the non-serving base station.

In one embodiment, the rules are communicated during the X2 setup phase. Alternatively or additionally, the rule sets may be preconfigured. For example there may be N rule sets. In that case, the serving BTS need only indicate which rule set the non-serving BTS is to use. This may reduce the amount of communication. N may be an integer greater than or equal to one.

Alternatively or additionally, the rules can be modified during use via the X2 and/or a similar interface.

In some embodiments, the non-serving base station may make a determination about signal quality, for example based on signal interference noise ratio. This may be used by signal combing algorithm in the serving base station. The data may be transmitted to the serving BTS with less resolution if the noise level is already high. If that information is determined by the non-serving base station, it may be sent to the serving base station.

In some embodiments, even if the serving BTS has advised the non-serving BTS of the subcarriers and/or TTI to be used for the data, if the serving BTS decides to use those radio resources for another purpose, that data can be omitted from the non-serving BTS.

Data from Non-Serving Base Station

In some embodiments, the non-serving base station can send data, for example in soft or hard coded format towards a serving BTS autonomously. This may be done if the non-serving BTS considers that the data may assist the serving BTS. This may be regardless of whether or not the serving BTS specifically required that information. This may occur for example, if a parameter of the physical resource block (e.g. the signal to interference noise ratio SINR) is meeting some predefined values for the PRB,s. Thus if the non-serving BTS is not using the radio resources (PRBs) for the UEs that it that it is serving but the non serving BTS notices that there was some data over the air on those radio resources during that time it will send that data to the possible serving BTS.

The non-serving base station can estimate the correct serving BTS based on the SON self optimizing network information or on some other radio network planning information.

### User Equipment Receiver Mode

A further mode may be a user specific reception mode. The serving BTS may only request the RX process if those user equipments which are in the CoMP set of the serving BTS are actually scheduled. Otherwise, the X2 link can be left empty and the non-serving BTS idle. The serving BTS informs the non serving BTS when there is some data that needs to be sent to that serving BTS.

The serving BTS may request:

1) I/Q data—(potentially reduced as previously described);
2) Fourier transformed, band limited and/or reduced data as described previously.
3) The serving BTS can request the decoded block and frame reliability information. For this mode, the serving BTS gives the user equipment specific information on the user equipment transmission mode (Modulation Coding scheme MCS) used PRB, etc. and/or timing reference information. This information may be similar to, for example PDCCH information (packet data control channel information).

If a CRC cyclic redundancy check at the non serving base station or similar indicates unsuccessful reception, no data needs to be sent by the non-serving base station to the serving base station.

In any one or more of the embodiments previously described, the non-serving BTS may decide not to send data to the serving base station or simply to send an indication that the data is not valid. This may be, for example if the user equipment signal has not been received by the non-serving base station or has been received with too high a level of interference. Alternatively or additionally, the non-serving base station may have alternatively used its uplink resources for other users.

Alternatively or additionally, the serving BTS 8 is able to decide how to use the data itself. For example in the hard coded case, the serving BTS receives hard decoded HARQ (hybrid automatic repeat request) frames and frame reliability information. The frame reliability information may, for example, be SINR. The serving BTS can select between the data itself as received, and on the other hand the non-serving frame based on the CRC, frame reliability information or can compare both. This may occur if, for example, the CRC is good.

The serving and non-serving BTS can negotiate the best transfer point or use predetermined transfer points. For example, this can be prior to FFT processing or after FFT processing. The transfer point is the point along the processing chain of FIG. 5 where the processing of the data received at the non-serving base station stops in the non serving base station and transfers to the serving base station where it is continued to be processed.

The transfer point, may be for example sending the data as IQ data (at the beginning of the processing chain), the IQ data after FFT, after demodulation, after turbo decoding, etc. This can vary depending on the load in the system and/or the required information, for example MRC/IRC (Maximal ratio combining/interference rejection combining).

In some embodiments, different transfer points may be provided for every PRB. Alternatively or additionally the non-serving base station may select the transfer point. Where the non-serving BTS selects the transfer point, that non-serving BTS may advise the serving BTS of the transfer point.

For example, if the non-serving BTS has congested uplink transport, the non-serving BTS may decide to send hard decoded symbols to reduce load, even if the serving BTS has requested IQ data. In that scenario, the non-serving BTS may advise the serving BTS about the type of data.

The non-serving BTS may use MCS information, if available, or send for example assuming data to the QSPK and then adding information about MSC.

Alternatively or additionally, the transfer points may be separated by cell level information. In the case of QSPK, the non-BTS may send the subcarriers using soft symbols. In the case of 16 QAM (quadrature amplitude modulation), the non-serving BTS may send the subcarriers on the TTI.

In some embodiments, the transfer points may be modified during operation of a system based on the need. In some embodiments, depending on the parameters, the modification may be done automatically.

Alternatively or additionally, using reduced sample resolution, in L1, it is possible to have different sample resolution and using a lower sample resolution may lead to a smaller traffic load. If there limited transport resources, then the non-serving and/or serving BTS may decide that lower resolution should be used to preserve transport capacities. A decision may be made not to send the data at all. Suppression of sending of the data may take place if the received signal does not match the required quality (e.g. SINR is too low for a desired or required MCS.

In some embodiments, SINR information, for example per TTI or PRB may be provided between the two base stations.

In some embodiments, the non-serving BTS may mark the priority of the packets (using for example differentiated service code points) and allow the dropping of packets which are not so important or have a lower quality of service This may be done where there is a low to SINR.

In some embodiments, synchronised information or procedures may be distributed over the X2 link or by any other means. In some embodiments, synchronisation information is added to the data to be sent. If only IQ data is sent, some time reference may be embedded. This may be used ensure that the data from the two sources can be combined in a generally aligned fashion. This information may, for example, be PR based information. This may allow the non-serving and serving BTS to not necessarily be synchronised, in some embodiments. In alternative embodiments the base stations may operate in a frame synchronised fashion.

In some embodiments, this may be applied in a BTS hotelling case. BTS hotelling is where some functions of a BTS/eNB are centralized.

In some embodiments one or more functions could also be split across the two base stations. For example equalisation could be partly in the serving BTS and partly in the non-serving BTS.

Some embodiments may be used in WCDMA, for example in a HSPA High Speed Packet Access context.

Reference is made to FIG. 6a which shows in more detail a receiver of an embodiment.

An FFT block 100 is provided which will receive, in one embodiment, from two or more antennas cell specific IQ data. In one example this may be 3 GB/s for two antennae at 20 MHz. The pilot output of the FFT block 100 is input to a parameter estimation unit 102 and the data output is provided to a combiner equaliser 103. In one example a hundred user specific PRBs are provided to the combiner equaliser.

The parameter estimation unit 102 provides parameter estimation for each antenna and provides an output to the combiner equaliser 103.

The input to the combiner equaliser 103 may be UE specific. A hundred PRBs may equate to 538 MPs. As discussed previously, one reduction of data option would be to transmit only data for UEs in CoMP. Additionally or alternatively, it is possible to reduce word width depths for low MCS.

The output of the combiner equaliser is input to an IFFT (inverse fast Fourier transform) unit 104.

The output of the IFFT unit is input to a soft slicer 105. The output of the soft slicer is soft symbols. As discussed previously, one reduction of data option from the output of the soft slicer would be to transmit only data for UEs in CoMP. Additionally or alternatively, it is possible to reduce word width depths for low MCS.

The output of the soft slicer is input to a decoder 106 with a HARQ buffer. One reduction of data option for the output of the decoder would be to transmit only data for UEs in CoMP. Additionally or alternatively, it is possible to reduce word width depths for low MCS.

The output of the decoder 106 is input to a second decoder stage 107 the output of which is input to a CRC (cyclic redundancy code) unit 108. One output of the CRC unit 108 is the HARQ/ACK output whilst another output is to a combiner 109. The output of the combiner is to an RLC unit 110 which provides an RLC/ACK output. The reduction options at this stage may depend on the maximum user rate.

As can be seen, from FIG. 6a, the data can be forwarded from various stages of a receiver data chain of a non serving cell to a serving cell with a number of reduction in data options available for different embodiments.

Reference is made to FIG. 6b. The receiver upstream of the decoder is as discussed in relation to FIG. 6a. The decoder provides an output to a first CRC unit 108′ which provides hard CRC combining. The output of the first CRC unit 108′ is to a HARQ unit 112.

The decoder 106 also provided a delayed pre-coded output to a delayed decoder stage 107′. One reduction of data option would be to transmit only data for UEs in CoMP. Additionally or alternatively, it is possible to reduce word width depths for low MCS.

The output of the delayed decoder stage 107′ is output to a second CRC unit 108″, the output of which is provided to the HARQ unit 112.

Some embodiments may be used in any suitable macro-diversity arrangement.

It is also noted herein that while the above describes exemplifying embodiments, there are several variations and modifications which may be made to the disclosed solution without departing from the scope of the present invention.

The required data processing apparatus and functions of a base station apparatus, a mobile communication device and any other appropriate station may be provided by means of one or more data processors. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of embodiments may be implemented in hardware, while other aspects may be implemented in firmware or software which may be executed by a controller, microprocessor or other computing device, although the invention is not limited thereto. While various aspects of the embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software executable by a data processor of a base station or its controller, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising at least one processor, and at least one memory including computer program code, wherein the at least one memory and the computer program code are configured, with the at least one processor:
to process received data in a non serving base station from at least one user equipment to reduce said data; and
to cause said processed data to be sent to a serving base station.

2-16. (canceled)

17. An apparatus comprising at least one processor, and at least one memory including computer program code, wherein the at least one memory and the computer program code are configured, with the at least one processor:
to cause a request from a serving base station to be sent to a non serving base station, said request comprising information for causing said non serving base station to reduce an amount of data to be sent from said non serving base station to said serving base station.

18. Apparatus as claimed in claim 17, wherein said information comprises at least one of:
information on cell specific parameters for processing of said data in the non serving base station;
user equipment scheduling information; and
information defining if said data is IQ data, soft symbols or hard symbols.

19. (canceled)

20. A method comprising:
processing received data in a non serving base station from at least one user equipment to reduce said data; and
causing said processed data to be sent to a serving base station.

21-24. (canceled)

25. A method as claimed in claim 20, wherein said processing comprises performing fast Fourier transformation of said data.

26. A method as claimed in claim 20, wherein said processing comprises performing demodulation of said data.

27. A method as claimed in claim 20, wherein said processing comprises performing decoding of said data.

28. A method as claimed in claim 20, said processing comprises using cell specific parameters from said serving base station for processing of said received data.

29. A method as claimed in claim 20, comprising causing said data to be sent only when scheduled.

30. A method as claimed in claim 20, wherein it at least one of said processing and causing data to be sent is responsive to information from said serving base station.

31. A method as claimed in claim 20, wherein said causing comprises causing one of IQ data, soft symbols or hard symbols to be sent to said serving base station.

32. A method as claimed in claim 20, wherein said causing comprises causing said data to be sent to said serving base station on an X2 link.

33. A method as claimed in claim 20, comprising causing said processed data only of user equipments which are controlled by said serving base station to be sent.

34. A method as claimed in claim 20, wherein said processing comprises carrying out a check on said data and only causing said data to be sent if said check is successful.

35. A method as claimed in claim 34, wherein said check comprises a cyclic redundancy check.

36. A method comprising:
causing a request from a serving base station to be sent to a non serving base station, said request comprising information for causing said non serving base station to reduce an amount of data to be sent from said non serving base station to said serving base station.

37. A method as claimed in claim 36, wherein said information comprises at least one of:
information on cell specific parameters for processing of said data in the non serving base station;
user equipment scheduling information;
information defining if said data is IQ data, soft symbols or hard symbols; and
information for causing data only of user equipments which are controlled by said serving base station to be sent to said serving base station.

38. A computer program comprising computer executable instructions which when run cause the method of claim 20 to be performed.

39-40. (canceled)

41. Apparatus as claimed in claim 1, wherein the at least one memory and the computer program code are configured, with the at least one processor to perform at least one of:
fast Fourier transformation of said data;
demodulation of said data;
decoding of said data;
cause said data to be sent only when scheduled;
send one of IQ data, soft symbols or hard symbols to said serving base station; and
a check on said data and cause said data to be sent only when scheduled if said check is successful.
